(19) United States
(12) Patent Application Publication
(10) Pub. No.: US 2024/0081461 A1
(43) Pub. Date: Mar. 14, 2024

(54) PROTECTIVE LAMINATE STRUCTURES AND RELATED ARTICLES

(71) Applicant: BOARD OF TRUSTEEES OF MICHIGAN STATE UNIVERSITY, East Lansing, MI (US)

(72) Inventors: Mahmoodul Haq, Okemos, MI (US); Sarah Jameel Mohammadi, Okemos, MI (US)

(21) Appl. No.: 18/272,855

(22) PCT Filed: Jan. 18, 2022
(86) PCT No.: PCT/US22/12707

§ 371 Date: Jul. 18, 2023

Related U.S. Application Data
(60) Provisional application No. 63/138,895, filed on Jan. 19, 2021.

(51) Int. Cl. A42B 3/12; A42B 3/06; A63B 71/10

(52) U.S. Cl. CPC A42B 3/124; A42B 3/063; A63B 71/10; A63B 2209/02; A63B 2220/53; A63B 2225/50

(57) ABSTRACT

The disclosure relates to a protective laminate structure that can be incorporated into a protective garment such as a sports helmet. The protective laminate structure includes lattice elements such as fiber bundles defining an open area between the lattice elements, a continuous flexible layer adjacent to the open fibrous lattice, and a flexible adhesion means such as high-elongation adhesives connecting the continuous flexible layer and the lattice elements of the open fibrous lattice. The protective laminate structures provide a structure in which energy from an impact is transferred/dispersed within the structure to limit and reduce both concussive and destructive/fracturing forces transmitted through the structure. Corresponding protective garments such as helmets are lighter yet safer relative to convention rigid-shell helmets, flexible yet prevent skull fracture, and small/conform closely to the head without transfer of impact forces.

### CROSS REFERENCE TO RELATED APPLICATION

Priority is claimed to U.S. Provisional Application No. 63/138,895 filed on Jan. 19, 2021, which is incorporated herein by reference in its entirety.

### STATEMENT OF GOVERNMENT INTEREST

None.

### BACKGROUND OF THE DISCLOSURE

### Field of the Disclosure

The disclosure relates to a protective laminate structure that can be incorporated into a protective garment such as a sports helmet. The protective laminate structure includes lattice elements such as fiber bundles defining an open area between the lattice elements, a continuous flexible layer adjacent to the open fibrous lattice, and a flexible adhesion means such as high-elongation adhesives connecting the continuous flexible layer and the lattice elements of the open fibrous lattice.

### BRIEF DESCRIPTION OF RELATED TECHNOLOGY

The athletic helmets in use today are designed based on athletic safety thresholds developed in 1950s that require prevention of skull fracture and associated fatalities. Hence the existing helmets are bulky, rigid and heavy. Current athletic helmets weigh in between 0.65 kg to 2.5 kg; the weight of the helmet itself can increase the whiplash effect and in some cases attenuate impact-induced effects. Similar problems are reported with defense applications, in which there is additional weight in the helmets due to communication systems and radios etc.

Current safety standards for helmets do not explicitly require reduction/prevention of concussions, and the current helmets are not particularly well suited for this purpose. For example, CTE (chronic traumatic encephalopathy (CTE)), which is a progressive, degenerative brain disease, has been found in 99 percent of brains of National Football League (NFL) players, as well as in 91 percent of college football players and 21 percent of high school football players.

Many of the attempts to address these shortcomings have focused on optimizing the helmet shell/outer layer with ribs and other energy-absorption features. Nevertheless, such helmets are not in practice due to their complexity of manufacturing, and also their ability to take only one impact/hit before needing to be replaced.

### SUMMARY

In one aspect, the disclosure relates to protective laminate structure comprising: (a) an open fibrous lattice (or network) comprising lattice elements defining an open (or void) area (or volume) between the lattice elements; (b) a continuous flexible layer adjacent to the open fibrous lattice; and (c) a flexible adhesion means (e.g., high-elongation adhesives) connecting the continuous flexible layer and the lattice elements of the open fibrous lattice. The lattice elements can include one or more of continuous fibers, tubes (e.g., solid or hollow elastomeric/rubber tubes), or loose fiber bundles. The continuous flexible layer can include an elastic and/or thermoplastic polymer layer. The flexible adhesion means can include a high-elongation adhesive, which can be useful to absorb energy.

Various refinements of the disclosed protective laminate structure are possible.

In a refinement, the lattice elements comprise loose fiber bundles. For example, the loose fiber bundles can comprise a plurality of loose fibers (i) substantially unbound to each other, but (ii) bound together as a unit (e.g., stitched together). In a further refinement, the loose fiber bundles comprise (or are formed from) a material selected from the group consisting of glass fibers, carbon fibers, rubber fibers, aramid fibers, thermoplastic fibers, and combinations thereof.

In a refinement, the lattice elements comprise tubular elements.

In a refinement, the open area defined by the lattice elements is in a range of 0.7 to 0.95 relative to an area defined by the fibrous lattice.

In a refinement, the open fibrous lattice comprises hexagonal lattice elements. In some refinements, the open fibrous lattice comprises other polygonal or variously shaped lattice elements in addition to or instead of hexagonal lattice elements.

In a refinement, the lattice elements have a spatially variable fiber density across the fibrous lattice.

In a refinement, the lattice elements have a thickness in a range of 0.5 mm to 5 mm.

In a refinement, the continuous flexible layer comprises a thermoplastic polymer.

In a refinement, the continuous flexible layer has a thickness in a range of 0.1 mm to 5 mm.

In a refinement, the laminate structure further comprises: a force sensor. In some refinements, the laminate structure can comprise wireless communication electronics and/or sensors for other than force (e.g., health data).

In a refinement, the laminate structure further comprises: a protective plate occupying at least a portion of the open area of the open fibrous lattice. In a particular refinement, the protective plate comprises (e.g., is formed from) a material selected from the group consisting of ceramic materials, metal materials, aramids, and combinations thereof.

In another aspect, the disclosure relates to a multilayer protective structure comprising: a plurality of laminate structures according to any of the variously disclosed embodiments and refinements, arranged in adjacent layers bound to each other. In a refinement, consecutive pairs of adjacent layers in the multilayer structure have a staggered lattice relationship relative to each other.

In another aspect, the disclosure relates to a protective garment comprising: a protective laminate structure or multilayer protective structure according to any of the variously disclosed embodiments and refinements. In a refinement, the protective garment further comprises a (foam) padding layer adjacent to the laminate structure (e.g., bound thereto with a suitable adhesive).

While the disclosed methods, compositions, and articles are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 is a side cross sectional view of a multilayer protective laminate structure according to the disclosure.

FIG. 2 is a top view of an open fibrous lattice according to the disclosure with a hexagonal lattice and spatially variable fiber bundle density/thickness.

FIG. 3 is a perspective view of an open fibrous lattice according to the disclosure with a hexagonal lattice and illustrating the stitching threads (light) binding the loose fibers (dark) together as a unit.

FIG. 4 includes exploded perspective view schematics for a protective garment according to the disclosure (right) and a comparative protective garment without the protective laminate structure according to the disclosure (left).

FIG. 5 includes simulation results for impact reaction force distribution for a protective garment according to the disclosure (right) and a comparative protective garment without the protective laminate structure according to the disclosure (left).

FIG. 6 is a graph showing the simulation result from FIG. 5 in terms of total force transmitted to a wearer of the protective garment as a function of time.

### DETAILED DESCRIPTION

There is a need for a shift in the design philosophy for helmets as well as other sports and protective garments in general, so as to ensure the reduction in concussions while also reducing or preventing skull fractures. The protective laminate structures disclosed herein address this need by providing a structure in which energy from an impact is transferred/dispersed within the structure to limit and reduce both concussive and destructive/fracturing forces transmitted through the structure (e.g., and to a user or wearer of a corresponding protective garment). The resulting protective laminate structures and corresponding protective garments are a) lighter yet safer, b) flexible (less rigid) yet prevent skull fracture, and c) small/conform closely to the head (to reduce whiplash) without transfer of impact forces. Contrary to conventional helmet design, a flexible helmet (e.g., having a flexible outer layer instead of a rigid shell), can be safer than a rigid helmet. In a given helmet design, the weakest link fails first: For the case of stiff and heavy helmets according to a conventional design, the skull/head of the wearer is the weakest link and hence receives the majority of the force, whereas flexible shells in the protective laminate structures according to the disclosure will allow for deformation of the helmet component prior to transfer of forces to the skull/head of the wearer. Hence, the disclosed protective laminate structures provide tailored paths for energy dispersion, which is more important than having stiffer and heavier helmets for protection of the user. The disclosed protective laminate structures also provide protection for rotational and shearing impacts, in addition to direct impacts (e.g., perpendicular or normal to the outer surface of the laminate structure). The disclosed protective laminate structures also provide protection against low-impact hits that provide a contribution to cumulative concussive brain injuries, even though the single low-impact hit would not cause fracture, etc. For defense applications, the disclosed protective laminate structures can also prevent penetration of a projectile through the helmet.

The disclosed protective laminate structures and corresponding protective garments have many advantages over conventional structures used in protective garments such as helmets, for example those having a rigid outer shell and an inner polystyrene foam energy absorbent core. The disclosed protective structures and garments generally can include a multi-layered structure using plastics, fiber-tows stitched in strategic patterns, motion-isolation foams arranged strategically to control the mechanisms of energy transfer, and incorporated sensors to measure the load transfer and the efficiency of the system. More specifically, the disclosed protective structures and garments can include multiple layers, each containing energy-absorbing mechanisms. The energy absorption mechanisms can be created using fibrous lattice elements (e.g., carbon fiber, aramid fiber or other material) without an encapsulating matrix, strategically placed in a honeycomb or other lattice pattern to create ‘fixed-fixed’ boundary conditions that allow for energy absorption using local bending of these fibrous lattice elements or beams, which can be achieved by using the open fibrous lattice material as a spacer between adjacent layers. The disclosed protective structures and garments can incorporate staggered adjacent lattice pattern layers, which allows for any/every spatial location of the protective structures to have this energy-absorbing mechanism. For defense applications the hollow regions of the lattice pattern can be filled with ceramic or other anti-ballistic plates to prevent penetration of projectiles. The disclosed protective structures and garments further include a hyperplastic or hyperelastic material to join adjacent layers. Adjacent layers are joined as selected locations using the hyperplastic or hyperelastic material, thus allowing the layers to deform and move with respect to each other while still remaining connected/bound to each other. This feature allows absorption and dissipation of rotational and shearing impacts (e.g., glancing hits and torsional hits) in addition to direct impacts. The disclosed protective structures and garments can include any suitable number of layers based on a given use (e.g., depending on a particular sport or defense application), and the composition and/or structure of adjacent layers likewise can be selected to be the same or different. The lattice elements or fiber bundles of the protective structures and garments can include various sensors such as a copper wire, piezoelectric fibers, or fiber optic sensor, to provide in-situ health monitoring of the garment and its wearer/user. The disclosed protective structures and garments can provide energy diversion and re-direction around the outer (or impact) location of the structures and garments, instead of energy penetration into inner parts of the helmet and the skull as for conventional hard-shell helmets. Hence, an individual wearing the disclosed protective garment experiences reduced impact force. The disclosed protective structures and garments can withstand multiple hits/impacts without being destroyed while being able to still perform their protective function, thus providing a longer useful life of the protective garment before replacement. The disclosed protective structures and garments are easily repairable and re-healable, in particular for low-velocity or low-force impacts. The disclosed protective structures and garments typically have a lower weight compared to a conventional protective structure having a rigid outer shell and no open fibrous lattice. For example, in some embodiments, a helmet or other protective garment according to the disclosure can have a weight of about 40% to 90% relative to that of a conventional helmet (or about 10% to 60% weight reduction), for example at least 40 or 50% and/or up to 60, 70, 80, or 90%. This reduced weight in turn reduces the whiplash risk to a wearer of the helmet, as there is less total mass away from the wearer's neck as a swivel point upon impact to the body or head.

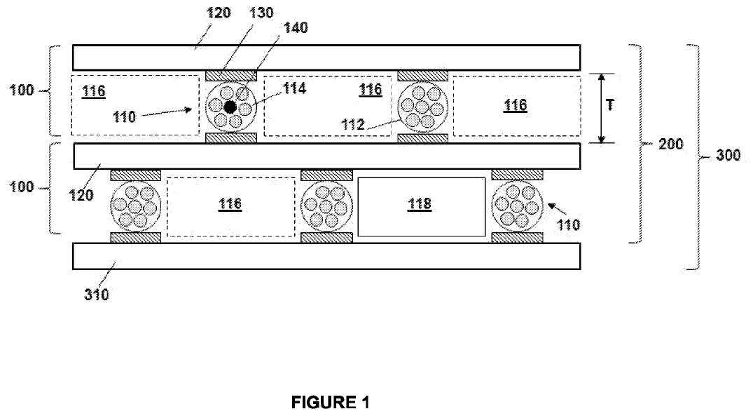

FIGS. 1-4 illustrate a protective laminate structure 100 according to the disclosure as well as a corresponding multilayer protective structure 200 and protective garment 300 incorporating the laminate structure 100. The protective laminate structure 100 includes an open fibrous lattice or network 110 with lattice elements 112 defining an open or void area or volume 116 between the lattice elements 112. The laminate structure 100 further includes a continuous flexible layer 120 adjacent to the open fibrous lattice 110 and a flexible adhesion means 130 connecting the continuous flexible layer 120 and the lattice elements 112 of the open fibrous lattice 110. The lattice elements 112 collectively define the open fibrous lattice 110, and they can define or create a uniform space or thickness T between adjacent layers in the laminate structure 100. The lattice elements 112 can include one or more of continuous fibers, tubes (e.g., solid or hollow elastomeric/rubber tubes), or loose fiber bundles. The continuous flexible layer 120 can include an elastic and/or thermoplastic polymer layer. The flexible adhesion means 130 can include a high-elongation adhesive, which can be useful to absorb energy.

In a refinement, the lattice elements 112 can be formed from or otherwise include loose fiber 114 bundles. For example, the loose fiber 114 bundles can include a plurality of loose fibers 114 that are substantially unbound to each other, but bound together as a unit. The loose fibers 114 are generally continuous fibers that are bound together as a unit using any suitable means, for example being stitched together with a circumferential thread 115 or fiber (e.g., same or different fiber type as that forming the bundle) holding the loose fibers 114 in close/touching proximity to each other. The individual loose fibers 114 are generally not bound to each other, for example via a glue, adhesive, or encasing polymer matrix, although a small fraction of fibers at the outer edge of a bundle might be adhered/bound together via the flexible adhesion means 130 binding the bundles to the continuous flexible layer 120. The loose fibers 114 are able to slide/spread relative to each other upon impact (e.g., normal and/or shearing force), which sliding/spreading facilitates the diffusion of impact force throughout the laminate structure 100. The stitching 115 or other means for binding the loose fibers 114 together maintains the bundle as a unit and generally restores the bundle to its original shape (e.g., quasi circular cross section for bundle aggregate) after impact.

The types of material for the fibers 114 are not particularly limited. Examples of suitable fiber materials include glass fibers, carbon fibers, rubber or elastomeric fibers, aramid fibers, thermoplastic fibers, etc. The rubber or elastomeric fibers can be formed from any suitable elastomer such as an unsaturated rubber (e.g., vulcanized polybutadiene, natural or synthetic polyisoprene, etc.) or a saturated rubber (e.g., ethylene propylene rubber, an ethylene propylene diene rubber, etc.). The aramid (or aromatic polyamide) fibers more generally can include high-strength synthetic impact-resistant or antiballistic materials such as KEVLAR, etc. The thermoplastic fibers can be formed from thermoplastic materials such as nylons or polyamides, polyesters (e.g., polyethylene terephthalate), polyether ether ketones (PEEK), polyolefins (e.g., polyethylene such as LDPE, HDPE, etc.), polycarbonates, acrylonitrile-butadiene-styrene (ABS) etc. The thermoplastic fibers can be used in combination with or in place of stitching as a means to bundle the loose fibers together, for example by thermally fusing or melting fibers together at selected locations while they remain free or unbound to each other at most locations (e.g., anchored or bound together at a limited number of points, but still generally able to slide/spread relative to each other upon impact).

The material or thread used for the stitching 115 is not particularly limited. Polyester threads are suitable, but the thread more generally can be formed from the same types of materials mentioned above for the fibers or loose fiber bundles, although the stitching thread and fibers/fiber bundles can be formed from the same or different materials in a given embodiment. Different stitching techniques or types can be used to control the rate and amount of bundle deformation upon impact as well as the rate of return to the original shape after impact. For example, threads can be selected to have a relatively high or low strength and/or stitch density (e.g., relatively close or far spacing of adjacent stitches). Threads with a relatively high strength and/or a relatively high stitch density can be used to group the fiber bundle together more tightly and more rapidly return the bundle to its original shape after impact. Similarly, threads with a relatively low strength and/or a relatively low stitch density can be used to group the fiber bundle together less tightly, thus allowing more deformation of the bundle upon impact and a slower return to its original shape after impact. In some embodiments, a thin flexible sleeve (e.g., polymeric sleeve) can be used to enclose the bundle of fibers, for example in addition to or in place of stitching. The sleeves similarly can be formed from the same types of materials mentioned above for the fibers or loose fiber bundles, for example a nylon or polyamide sleeve, a carbon sleeve, etc.

In some embodiments, the lattice elements 112 can include tubular elements, for example continuous solid or hollow tube formed from a flexible material such as a rubber or other material described above for the fiber bundle. In this embodiment, a single tubular element can be used in place of a plurality of fibers in a fiber bundle as an individual lattice element. Of course, multiple tubular elements can be used to collectively define the overall fibrous lattice network.

As particularly illustrated in FIGS. 1-3, the open area 116 is generally the space between the lattice elements (or loose fiber bundles) 112, for example being generally hexagonal areas in a hexagonal lattice. The open area 116 is expressed as a fraction (or percent) relative the fibrous lattice 110 as a whole. For example, for a given fibrous lattice 110 in which A_{V} represents the void or open area and A_{F} represents the lattice element or fiber bundle area, then the fraction A_{V}/(A_{V}+A_{F}) for the open area 116 the fibrous lattice 110 can be in the range of 0.7 to 0.95, for example being at least 0.7, 0.75, 0.8, or 0.85 and/or up to 0.8, 0.85, 0.9, or 0.95. As used herein, “area” along with its corresponding ranges can reflect a two-dimensional area in a plane or surface defined by the fibrous lattice 110, or it can equivalently reflect a three-dimensional volume in an equivalent layer defined by the fibrous lattice 110. In some embodiments, the open area 116 is simply a void, such as being occupied by air or other gas. In some embodiments, the open area can be occupied by solid or liquid material 118, in which case the occupied space is still considered to be an “open area” relative to the fibrous lattice 110. Examples of solid materials 118 that can fill the open area 116 include a ceramic material, a metal material, or other protective/anti-ballistic plate material. In some cases, the open area 116 can be occupied by a fluid, a filler, a fluid with filler, etc., for example being encased in an individual pouch (e.g., having a hexagonal or other shape generally corresponding to that of the open area 116).

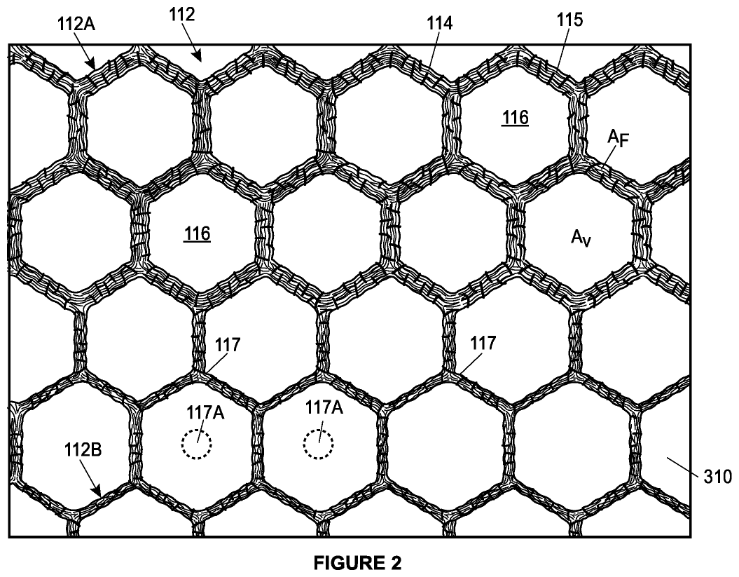

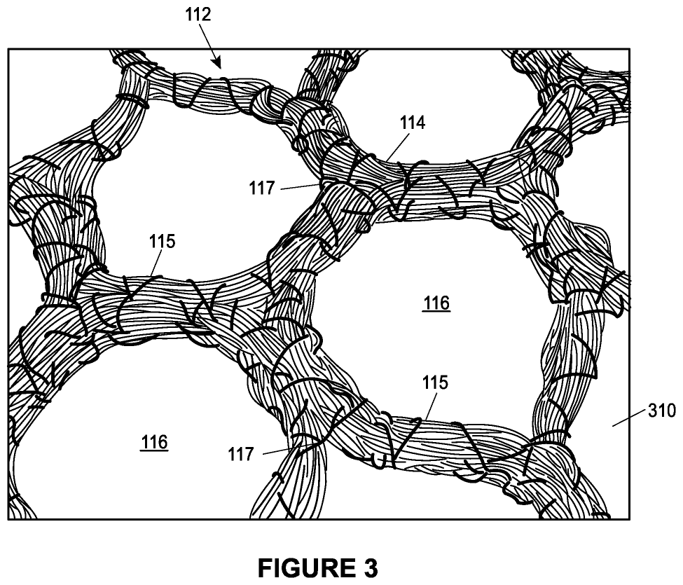

The lattice elements 112 and corresponding open areas 116 of the fibrous lattice 110 can generally have any suitable shape, whether a polygon, regular polygon, or otherwise, such as a hexagon, pentagon, rectangle, triangle with the same or different side/edge lengths. For example, FIGS. 2-3 illustrate a hexagonal shape for the lattice elements 112 and corresponding open areas 116. The lattice elements 112 can all have the same shape, or they can be different shapes for different elements, such as a combination of pentagons and hexagons (e.g., as used on a football/soccer ball for a curved or non-flat surface). Similarly, the lattice elements 112 can have the same or different sizes/edge lengths in the overall fibrous lattice 110. In some embodiments, one or more regular polygonal shapes are used for convenience, for example in a repeated pattern to cover a desired total area or surface for a single protective laminate structure 100. Particularly suitable (regular) polygonal shapes useful for covering a protective laminate structure of arbitrary shape include a combination of hexagons, pentagons, and/or triangles.

In some embodiments, the lattice elements (or loose fiber bundles) 112 can have a spatially variable fiber density across the fibrous lattice 110. This embodiment is illustrated in FIG. 2 with areas showing thicker lattice elements 112A (e.g., having more fibers or a higher fiber density in a bundle cross section) and areas showing thinner lattice elements 112B (e.g., having fewer fibers or lower fiber density in a bundle cross section). The thicker/higher density lattice elements or bundles 112A can provide more impact resistance in desired targeted areas. For example, thicker lattice elements or bundles 112A can be used to absorb more energy and to transfer or direct energy away from a certain area. Also, lattice elements or bundles 112A bundles increase the space between adjacent layers 120 in a laminate structure 100, thereby allowing for more bending and energy absorption.

The lattice elements (or loose fiber bundles) 112 can have a thickness in a range of 0.5 mm to 5 mm or 0.5 mm to 10 mm, for example at least 0.5, 0.7, 1, 1.2, 1.5, 2, 2.5, or 3 mm and/or up to 2, 3, 4, 5, 7, or 10 mm. The thickness value can represent a width or diameter of lattice elements 112, for example the width or diameter of a cross-section thereof, whether for the collectively plurality of fibers in a loose bundle or a single tubular element or fiber. As described above, the thickness of the lattice elements or bundles 112 can be selected to control impact resistance of the protective laminate structure 100, for example having a spatially uniform thickness or fiber density across the laminate structure 100, or having a spatially variable thickness or fiber density across the laminate structure 100. As illustrated in FIG. 1, the thickness T between adjacent layers in the laminate structure 100 can generally correspond to the thickness of the lattice elements, for example 0.5 mm to 5 mm or 0.5 mm to 10 mm. Individual fibers used in the bundle can have a single-fiber diameter on the nanoscale or microscale, for example having individual diameters ranging from tens of nanometers to tens of microns. In various embodiments, the individual fibers can have a diameter (or average diameter) of 10 nm to 1000 nm (at least 10, 20, 50, or 100 nm and/or up to 50, 100, 200, 400, 600, or 1000 nm) or 0.1 μm to 50 μm (e.g., at least 0.1, 0.2, 0.5, 1, 2, or 5 μm and/or up to 1, 2, 5, 10, 20, 30, 40, or 50 μm).

In some embodiments, the continuous flexible layer 120 can be formed from or otherwise include a thermoplastic material. The thermoplastic material for the flexible layer 120 can be formed from the same or different thermoplastic materials as those above for the thermoplastic fibers. For example, suitable thermoplastic materials for the flexible layer 120 can include on or more of nylons or polyamides, polyesters (e.g., polyethylene terephthalate), polyether ether ketones (PEEK), polyolefins (e.g., polyethylene such as LDPE, HDPE, etc.), polycarbonates, acrylonitrile-butadiene-styrene (ABS) etc. In embodiments, the continuous flexible layer 120 can be formed from or otherwise include a material other than or in addition to a thermoplastic material, for example a rubber or elastomeric material as described above for the fiber materials. Similarly, the continuous flexible layer 120 can include a fiber reinforcement such as one of the materials described above for the fibers 114, for example one or more of glass fibers, carbon fibers (e.g., a carbon fiber-reinforced plastic/polymer (CFRP)), rubber or elastomeric fibers, aramid fibers, thermoplastic fibers, etc. In another embodiment, the continuous flexible layer 120 can include a thin metallic material (e.g., in addition to or in place of a thermoplastic material) that is sufficiently thin and flexible to conform to the shape of the open fibrous lattice 110 and/or the corresponding protective garment 300.

The continuous flexible layer 120 can have any suitable thickness, for example being thin enough to deform upon impact but thick enough to avoid rupture upon impact. In some embodiments, the continuous flexible layer 120 can have a thickness in a range of 0.1 mm to 5 mm or 0.2 mm to 3 mm, for example at least 0.1, 0.2, 0.3, 0.5, 0.7, 1, 1.2, or 1.5 mm and/or up to 0.5, 1, 1.5, 2, 3, 4, or 5 mm. For example, in embodiments where the continuous flexible layer 120 is or includes a thermoplastic materials, a layer 120 thickness of 1-3 mm or 0.5-4 mm is particularly suitable. In embodiments including aramid and/or carbon fibers in the open fibrous lattice 110 of the laminate structure 100, a layer 120 thickness of 0.2-3 mm or 0.1-4 mm is particularly suitable.

In some embodiments, the flexible adhesion means 130 can include a hyperflexible glue (or hyperflexible adhesive). Hyperflexible glues/adhesives are generally known in the art and are able to undergo relatively high degrees of elongation or strain in response to an impact, which allows them absorb energy and deform upon impact, thereby helping to distribute the impact energy throughout the laminate structure 100 while causing the laminate structure 100 to return to its original shape after impact. For example, a hyperflexible glue/adhesive can withstand elongations or strains up to 1000% before rupture or separation from its substrate (e.g., elongation from original length/dimension up to 10 times original length/dimension), for example at least 150, 200, or 300% and/or up to 400, 500, 600, 800, or 1000%. In some embodiments, blends or combinations glues/adhesives can be used to obtain a desired degree of flexibility. Examples of suitable high-elongation glues or adhesives suitable as a hyperflexible glue/adhesive include polyurethanes, polyureas, silicones, and other toughened glues (e.g., including a nano- or micro-filler such as a nanometer- or micron-sized particle or fiber distributed throughout the glue matrix). Conventional glues/adhesives (e.g., epoxies, etc.) have relatively very low elongations but relatively higher stiffness (or modulus; ability to carry load). On the other hand, high elongation (or toughness/ductility) glues/adhesives have relatively low stiffness. Stiffness (or modulus) and elongation (or toughness/ductility) are opposing parameters. Addition of nanoparticles, fillers, or modification to the glues as described above provides a desired stiffness-toughness balance based on the application. For the disclosed protective structures, a relatively high elongation and a relatively low stiffness are particularly suitable for the hyperflexible glue/adhesive to enable energy absorption. Nevertheless, the stiffness should be adequate to hold the components of the protective structure or garment together, which can be controlled by increasing or otherwise selecting the glue area (e.g., adhering the continuous flexible layer and lattice elements at some areas but not others). For example, a selected glue area does not require adhering the fiber bundles to the laminates above and below; instead the fiber bundles or other lattice elements can be adhered (only) around the vertices of the lattice structure (e.g., hexagons or other polygons), which in turn allows for more movement and better absorption of impacts while keeping the protective structure components intact.

In some embodiments, the protective laminate structure 100 further includes one or more sensors 140 for detecting, quantifying, and/or (continuous) monitoring of impact force experienced by the protective laminate structure 100, for example as a spatial function of location in the structure 100 (i.e., based on positioning of the sensor(s) 140 therein). Such force sensors are not particularly limited and are commercially available in various forms such as fiber optics, copper wires, piezo-electric wafers/fibers, and other force sensors. As particularly illustrated in FIG. 1, the sensors 140 can be included as a part of the lattice elements 112, for example being incorporated with the loose fibers 114 in the fiber bundles. In another embodiment, (not shown), the sensors 140 can be embedded within the flexible adhesion means 130. The sensors 140 can be used to monitor the impact and/or transfer of force upon and within the laminate structure 100. In some embodiments, the laminate structure 100 or corresponding protective garment 300 (e.g., within a helmet) can include any suitable conventional wireless communication electronics (not shown) to which the sensors 140 are (electrically) connected to provide a (real-time) transfer of all impact/force information to a remote computing station or terminal for evaluation. In some embodiments, the sensors can also be used to measure or receive/transfer/transmit occupant health data, for example sports science or health data such as heart rate, blood pressure, etc., which could be measured by a sensor internal or external to the protective structure before transmission. In some embodiments, a void open area 116 in between the lattice elements 112 can be used as a placement location the sensors or communication devices both for defense and athletic applications.

In some embodiments, the protective laminate structure 100 further includes a protective plate as the solid material 118 occupying at least a portion of the open area 116 of the open fibrous lattice 110. For example, the laminate structure 100 can include a plurality of protective plates occupying a plurality of open regions collectively defining the open area 116, such as hexagonal plates in hexagonal regions defined by a hexagonal fibrous lattice 110. In various embodiments, the protective plate can be formed from or otherwise include one or more materials such as ceramic materials, metal materials, and aramids. The materials for the protective plate are not particularly limited and can be any conventional material used for anti-ballistic use and/or blast protection, for example to resist or prevent penetration of bullets, other projectiles, shrapnel, etc. In a multilayer protective laminate structure 100, one or more layers can include the protective plates, and one or more other layers can be free from protective plates (e.g., having open void areas 116 to diffuse impact and resist non-destructive or otherwise catastrophic impact events). Examples of suitable ceramic materials include alumina and silicon carbide, a suitable metal material includes steel, and examples of suitable aramids or aromatic polyamides include the materials mentioned above for corresponding fibers in the lattice elements 112. The protective plates can have a thickness in a range of 0.5 mm to 5 mm or 0.5 mm to 10 mm, for example at least 0.5, 0.7, 1, 1.2, 1.5, 2, 2.5, or 3 mm and/or up to 2, 3, 4, 5, 7, or 10 mm.

In some embodiments, the protective laminate structure 100 further includes a fluid as the material 118 occupying at least a portion of the open area 116 of the open fibrous lattice 110. Fluids with and without fillers can be used to further absorb impact energy. The fluids, whether gas or liquid, can be enclosed in an individual pouch (e.g., having a hexagonal or other shape generally corresponding to that of the open area 116). The fluids can be gases such as one or more of air, nitrogen, oxygen, carbon dioxide, or other combinations. The fluid can include one or more of a Newtonian or non-Newtonian fluid of liquid, such as one or more of oils, liquid nanoparticle suspensions, cornstarch/water mixtures, and other fluids that absorb and dissipate impact energy. The fluid materials in a corresponding pouch can have a thickness in a range of 0.5 mm to 5 mm or 0.5 mm to 10 mm, for example at least 0.5, 0.7, 1, 1.2, 1.5, 2, 2.5, or 3 mm and/or up to 2, 3, 4, 5, 7, or 10 mm.

The disclosure further relates to a multilayer protective structure 200 including a plurality of the laminate structures 100 arranged in adjacent layers that bound to each other, for example as illustrated in FIG. 1. In a series of adjacent layers, the continuous flexible layer 120 of a single laminate structure unit 100 can be the “top” cover of its laminate structure unit 100 and also be the corresponding “bottom” cover of the adjacent laminate structure unit 100, for example having an additional interlayer flexible adhesion means 132 binding the adjacent layers together. The additional flexible adhesion means 132 can be formed from the same or different hyperflexible glue or adhesive materials as those used for the flexible adhesion means 130. The components of an individual laminate structure 100 can be the same or different as those of laminate structures 100 in the adjacent layer(s). In some embodiments, the flexible adhesion means 130 can either be applied continuously or at discrete points. For example, the adhesion means 130 can be applied to all areas of the lattice elements 112 or at discrete points thereof.

As further illustrated in FIG. 1, consecutive pairs of laminate structures 100 in adjacent layers can have a staggered lattice relationship relative to each other. A staggered lattice can be characterized in that nodal points 117 of the lattice elements 112 (or loose fiber bundles) in one laminate structure 100 layer are generally above/below the open area 116 of the adjacent laminate structure 100 layer. While the plane projections of adjacent lattices cross/intersect in some regions, the majority of the lattice elements 112 in a given layer is not directly above/below corresponding lattice elements 112 in the adjacent layer. For example, the staggered lattice can be placed such that the nodal points 117 (or apex or vertices) of the lattice elements 112 can be placed in the center of the corresponding open areas 116 (or solid materials/protective plates 118) in the adjacent layer. This is illustrated in FIG. 2, where nodal points 117 in a given laminate structure 100 layer are indicated as well as locations of nodal points 117A in an adjacent laminate structure 100 layer (i.e., shown with dashed lines as a projection of the nodal point 117A location in the adjacent layer). The staggered lattice arrangement allows for transfer of impact forces in one layer to the open areas 116 (or solid materials/protective plates 118) of the adjacent layer, thereby absorbing energy.

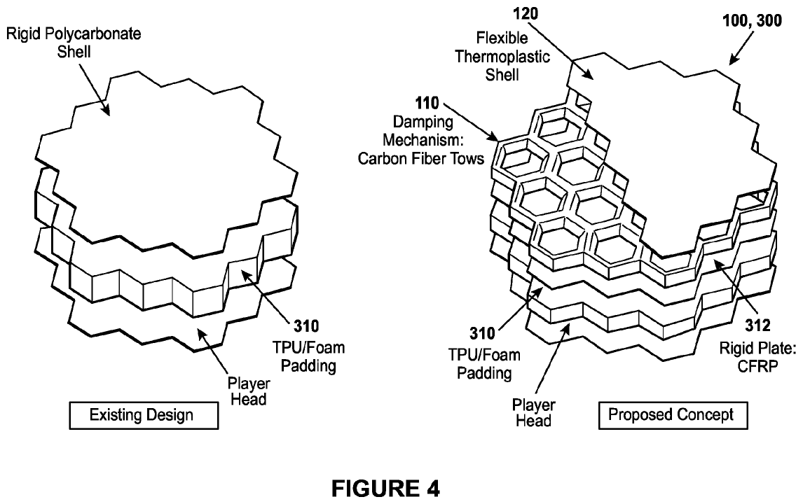

The disclosure further relates to a protective garment 300 including the protective laminate structure 100 or multilayer protective structure 200, for example as illustrated in FIG. 1. The protective garment 300 can be a helmet for head protection in a typical embodiment, but it more generally can be sized/shaped to provide padding, body armor, or other protection to any body part, for example shoulders, arms, hands, chest, back, torso, legs, feet, etc. The continuous flexible layer 120 is generally on the outer or impact side of the protective garment 300, and the open fibrous lattice 110 is generally on the inner or wearer side of the protective garment. As further shown in FIG. 1, the protective garment 300 can further include a foam or padding layer 310 adjacent to the laminate structure 100 (or the innermost laminate structure 100 in a multilayer protective structure 200), for example being bound thereto with a suitable adhesive such as those described above for the flexible adhesion means 130, 132. In some embodiments, the foam or padding layer 310 can be directly bound to the lattice elements 112 of the adjacent laminate structure 100 (e.g., via the flexible adhesion means 132 as shown in FIG. 1). In other embodiments, the foam or padding layer 310 can bound to the lattice elements 112 of the adjacent laminate structure 100 via one or more intermediate layers, for example another continuous flexible layer 120, a continuous protective layer 312, or otherwise. The continuous protective layer 312 is illustrated in FIG. 4 (right) and can generally be selected from the same materials and have the same dimensions (e.g., thickness values) as the continuous flexible layer 120, but it need not be the same as the continuous flexible layer 120 in a given embodiment. Suitably, the continuous protective layer 312 includes a fiber reinforcement to provide some rigidity/resilience, while the layer 312 is sufficiently thin and flexible to conform to the shape of the protective laminate structure 100 and/or the corresponding protective garment 300 (e.g., the underlying foam or padding layer 310).

Any desired material can be used for the foam or padding layer 310. For example, foams of varying densities can be used as well as motion-isolating foams such as auxetic materials. A wide range of foams are commercially available and are suitable for the foam or padding layer 310. Foams that can deform locally and prevent transfer of forces to other areas are preferred. In an embodiment, the foam or padding layer 310 is a polyolefin or polyurethane foam, for example an auxetic polyolefin or polyurethane foam.

The protective laminate structure 100 can be assembled by any convenient method. As described above, the lattice elements 112 (e.g., fiber bundles thereof) can be formed into the desired open fibrous lattice 110 shape via one or more of stitching, thermoplastic or adhesive joining, and encasing in a sleeve of the individual lattice elements 112. Once formed, the open fibrous lattice 110 can be joined to the continuous flexible layer 120 via application of the flexible adhesion means 130 therebetween, for example in a heated (e.g., molten) or uncured state, whereupon after cooling or curing the flexible adhesion means 130 forms the flexible bond between the lattice 110 and layer 120.

### EXAMPLES

The following examples illustrate the disclosed articles and methods, but are not intended to limit the scope of any claims thereto. In the following examples, computational impact simulations were performed to simulate and evaluate the effect of impact upon a protective structure according to the disclosure (or “proposed concept” in FIGS. 4-6) as compared to the effect of impact upon a conventional or comparative protective structure (or “existing design” in FIGS. 4-6).

Numerical finite element models of the disclosed and comparative protective structures were created in the commercially available software ABAQUS (Dassault Systems) for computer-aided engineering simulation. FIG. 4 (left) shows the comparative protective structure consisting of a thermoplastic polyurethane (TPU) foam padding layer adjacent to a wearer's head (e.g., modeled as a rigid plate for the skull of a player wearing a helmet incorporating the protective structure) and an outer rigid polycarbonate shell. FIG. 4 (right) shows the protective structure according to the disclosure, which includes an approximately half-height foam layer 310 relative to that in the comparative structure, but which further includes an outer protective laminate structure 100 according to the disclosure with a single open fibrous lattice 110 (carbon fiber tows) and a single continuous flexible thermoplastic layer 120 as the outer (impact) layer. As also shown in FIG. 4 (right), the protective structure 100 and/or garment 300 according to the disclosure can include a continuous protective layer 312 between the laminate structure 100 and the foam layer 310 as part of an overall protective garment 300. In the illustrated simulation embodiment, the continuous protective layer 312 was modeled as a carbon fiber-reinforced plastic/polymer (CFRP) material having a thickness of about half that of the outer rigid polycarbonate shell in the comparative protective structure. The thin continuous protective layer 312 is generally flexible and conforms to the shape of the protective garment and can deform/return to its original shape upon impact, in particular when it includes a fiber reinforcement.

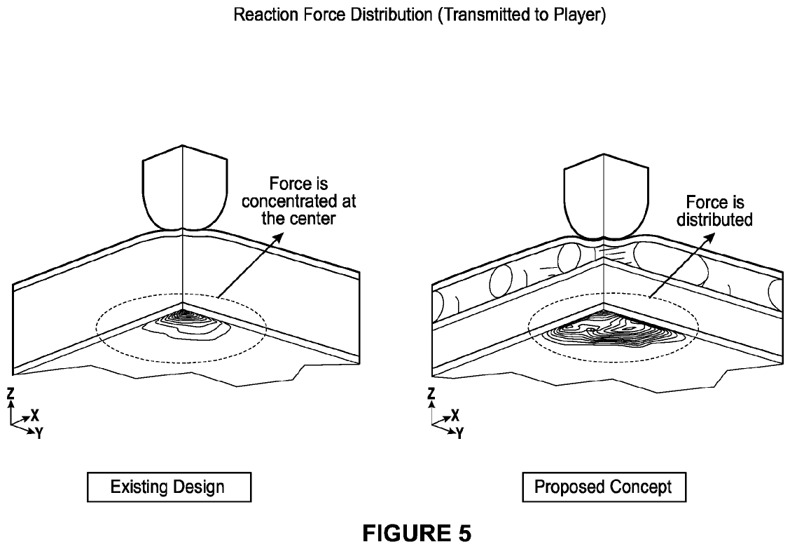

Both protective structures were subjected to exactly similar impact loads and boundary conditions in the impact simulations. The properties of the foams and rigid layers were also the same. The main difference between the two protective structures was the incorporation of hexagonal carbon fiber lattices in the corresponding protective laminate structure 100 for the protective structure according to the disclosure. The force on the plate in the bottom layer of each structure was computationally measured as a representation of the impact that would be absorbed by a human skull (i.e., a wearer of a helmet including the protective structure). FIG. 5 shows the distribution of forces at the bottom plate representing the skull. It was found that in the comparative protective structure (FIG. 5, left), the forces at the skull were more spatially concentrated and exhibited relatively larger peak forces (e.g., about 4-5 times higher peak force) compared to the protective structure according to the disclosure (FIG. 5, right). Furthermore, in the protective structure according to the disclosure, the forces were distributed over a larger area and were relatively lower (FIG. 5, right) than in the comparative structure (FIG. 5, left). This indicates that the force or acceleration experienced by the wearer of a protective garment incorporating the protective structure according to the disclosure would be considerably lower.

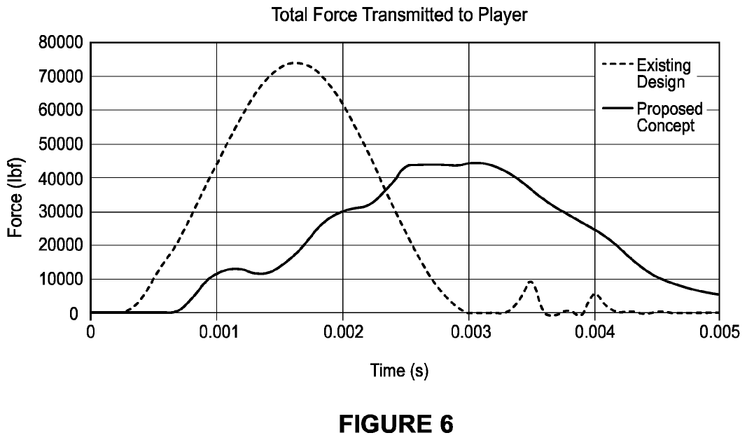

FIG. 6 similarly shows a plot of the transient force transmitted to the wearer as a function of time after impact. It is evident that the total force in the disclosed protective structure (solid line) is lower than that of the comparative protective structure (dashed line). Additionally, the same net or total impact energy is transmitted over a larger time, thus decreasing the peak force transmitted. This reduces the maximum g-force acceleration experienced by the wearer, and in turn reduces concussion-related injuries (e.g., to a player's or other wearer's head for a helmet protective garment).

Furthermore, this simulation used linear elastic materials with no damping. In practice, however, friction between fiber tows, and viscous damping media introduced between the fiber tow hexagons (e.g., a flexible adhesion means according to the disclosure) would further reduce the total energy being transmitted. In other words, the simulations of this example provide conservative estimates of the efficiency and ability of the disclosed protective structures to absorb and disperse impact forces.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### PARTS SUMMARY

100: protective laminate structure
110: open fibrous lattice
112: lattice element (e.g., loose fiber bundles where outer circle can denote stitching of bundle)
114: loose fibers
115: stitching/thread
116: open area
117: nodal point of lattice
118: open area with solid or fluid material such as a protective plate
120: continuous flexible layer
130: flexible adhesion means
200: multilayer protective structure
300: protective garment
310: foam or padding
312: continuous protective layer
A_{V}: void or open area
A_{F}: lattice element or fiber bundle area
T: thickness between adjacent layers in the laminate structure

What is claimed is:

1. A protective laminate structure comprising:
(a) an open fibrous lattice comprising lattice elements defining an open area between the lattice elements;
(b) a continuous flexible layer adjacent to the open fibrous lattice; and
(c) a flexible adhesion means connecting the continuous flexible layer and the lattice elements of the open fibrous lattice.

2. The protective laminate structure of claim 1, wherein the lattice elements comprise loose fiber bundles.

3. The protective laminate structure of claim 2, wherein the loose fiber bundles comprise a plurality of loose fibers (i) substantially unbound to each other, but (ii) bound together as a unit.

4. The protective laminate structure of claim 2, wherein the loose fiber bundles comprise a material selected from the group consisting of glass fibers, carbon fibers, rubber fibers, aramid fibers, thermoplastic fibers, and combinations thereof.

5. The protective laminate structure of claim 1, wherein the lattice elements comprise tubular elements.

6. The protective laminate structure of claim 1, wherein the open area defined by the lattice elements is in a range of 0.7 to 0.95 relative to an area defined by the fibrous lattice.

7. The protective laminate structure of claim 1, wherein the open fibrous lattice comprises hexagonal lattice elements.

8. The protective laminate structure of claim 1, wherein the lattice elements have a spatially variable fiber density across the fibrous lattice.

9. The protective laminate structure of claim 1, wherein the lattice elements have a thickness in a range of 0.5 mm to 5 mm.

10. The protective laminate structure of claim 1, wherein the continuous flexible layer comprises a thermoplastic polymer.

11. The protective laminate structure of claim 1, wherein the continuous flexible layer has a thickness in a range of 0.1 mm to 5 mm.

12. The protective laminate structure of claim 1, wherein the flexible adhesion means comprises a hyperflexible glue.

13. The protective laminate structure of claim 1, further comprising:
a force sensor.

14. The protective laminate structure of claim 1, further comprising:
a protective plate occupying at least a portion of the open area of the open fibrous lattice.

15. The protective laminate structure of claim 14, wherein the protective plate comprises a material selected from the group consisting of ceramic materials, metal materials, aramids, and combinations thereof.

16. A multilayer protective structure comprising:
a plurality of protective laminate structures according to claim 1 arranged in adjacent layers bound to each other.

17. The multilayer protective structure of claim 16, wherein consecutive pairs of adjacent layers have a staggered lattice relationship relative to each other.

18. A protective garment comprising:
the protective laminate structure of claim 1.

19. The protective garment of claim 18, further comprising:
a padding layer adjacent to the laminate structure.

20. A protective garment comprising:
the multilayer protective structure of claim 16.
